(19) United States
(12) Patent Application Publication
(10) Pub. No.: US 2012/0180376 A1
(43) Pub. Date: Jul. 19, 2012

(54) SLIP BOBBER

(76) Inventor: Donald Wayne Nelson, Sedalia, MO (US)

(21) Appl. No.: 13/349,230

(22) Filed: Jan. 12, 2012

Related U.S. Application Data
(60) Provisional application No. 61/432,509, filed on Jan. 13, 2011.

(51) Int. Cl. A01K 93/00

(52) U.S. Cl. 43/44.9

(57) ABSTRACT

A slip bobber broadly includes a float and a securing mechanism. The float has a float body and a line retainer receiver disposed within the float body and partially extending through an exterior face thereof. The line retainer has a line retainer body with a clip and a securing mechanism disposed thereon. The securing mechanism removably secures the line retainer within the line retainer receiver.

### RELATED APPLICATIONS

This application claims the benefit of U.S. Provisional Patent Application No. 61/432,509, filed Jan. 13, 2011 which is incorporated by specific reference in its entirety herein.

### FIELD OF THE INVENTION

This present invention relates to fishing tackle. More particularly, the invention relates to fishing bobbers.

### BACKGROUND

Bobbers are one of the most common types of fishing tackle because they allow an easy visual indication of fish activity without disturbing the bait. One drawback to conventional bobbers is that, because they are fixed on fishing line, relative to the hook, casting the line can be difficult, particularly at depths greater than several feet. Slip bobbers allow the bobber to slide along the fishing line between two line stops placed proximal and distal to the slip bobber along the fishing line. This facilitates casting of the line in a conventional manner without requiring a bobber at a fixed location on the fishing line.

Despite their advantages, slip bobbers possess several shortcomings. Many varieties of conventional slip bobbers require removal of the distal line stop to change the bobber for altered bait, for weight placed on or removed from the line, or for varying environmental conditions, such as dusk, clouds, or the like. Most varieties of conventional slip bobbers also utilize a stick that rises vertically several inches above and below the float. In windy conditions, the stick above the float can cause conventional slip bobbers to tilt, making it difficult for a user to discern whether a fish is present. Additionally, the stick makes conventional slip bobbers difficult to store compactly within a conventional tackle box.

### SUMMARY

The present invention solves the above-described problems and provides a distinct advance in the art of slip bobbers. More particularly, the present invention provides a slip bobber that has easily changed floats, does not tip in the wind, and fits conveniently in a conventional tackle box.

One embodiment of a slip bobber broadly includes a float and a line retainer. The float indicates when fish are present and includes a line retainer receiver and a float body. The line retainer includes a j-shaped clip and a cam-like securing mechanism that matingly engages a corresponding channel on the line retainer receiver. When assembled, a fishing line is slidably secured within a concave portion of the j-shaped clip and the slip bobber is positioned within the proximal line stop and the distal line stop.

An embodiment of a line retainer includes a body, an eye, and a spring. The eye includes a gap to allow a fishing line to be placed therewithin. The eye prevents the fishing line from being inadvertently removed from the eye.

Another embodiment of a slip bobber includes a float, a line retainer, a proximal line stop, and a distal line stop. In this embodiment, two line retainer receivers are positioned at opposite ends of the float. The line retainer includes a helical flange that matingly engages a corresponding helical channel on each line retainer receiver.

The slip bobber described herein possesses several advantages over prior art slip bobbers. In particular, embodiments of the present technology allow for easy replacement of the float, whether to change the color or size of the float or to change the size of the bait, without replacing or retying the proximal line stop or the distal line stop. For example, a user may want to substitute the float with another float of a different color as environmental conditions change. In particular, the user may change to a float with a black upper half if the environment becomes cloudy or may change to a float with a white upper half if the environment becomes sunny. Additionally, the user may choose to substitute the float with a larger or smaller float or to remove the bobber entirely, for example, when the user changes the catching mechanism or bait or when the user switches to straight-line fishing. Also, because embodiments of the present technology do not use long sticks that extend through the float and extend generally vertically from the surface of the water, they do not tip in the presence of wind and they fit more efficiently within a compartment of a conventional tackle box.

This summary is provided to introduce a selection of concepts in a simplified form that are further described below in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present technology are described in detail below with reference to the attached drawing figures, wherein:

FIG. 1 is an elevation view of a slip bobber constructed in accordance with an embodiment of the present invention showing the slip bobber, a fishing pole, a line, and a catching mechanism;

FIG. 2 is an isometric view of the slip bobber of FIG. 1 particularly illustrating a float, a line retainer, and a line retainer receiver;

FIG. 3 is an elevation view of the slip bobber of FIG. 1 including a cut line;

FIG. 4 is a cutaway view of the slip bobber of FIG. 1 along the cut line of FIG. 3;

FIG. 5 is an isometric view of the line retainer of FIG. 1;

FIG. 6 is an isometric view of a line retainer constructed in accordance with a second embodiment of the present invention;

FIG. 7 is an elevation view of a slip bobber constructed in accordance with a third embodiment of the present invention including a cut line; and

FIG. 8 is a cutaway view of the slip bobber of FIG. 7 along the cut line of FIG. 7.

The drawing figures do not limit the present invention to the specific embodiments disclosed and described herein. The drawings are not necessarily to scale, emphasis instead being placed upon clearly illustrating the principles of the technology.

### DETAILED DESCRIPTION

The following detailed description of various embodiments of the present technology references the accompanying drawings which illustrate specific embodiments in which the technology can be practiced. The embodiments are intended to describe aspects of the technology in sufficient detail to enable those skilled in the art to practice them. Other embodiments can be utilized and changes can be made without departing from the scope of the technology. The following detailed description is, therefore, not to be taken in a limiting sense. The scope of the present technology is defined only by the appended claims, along with the full scope of equivalents to which such claims are entitled.

Note that in this description, references to “one embodiment” or “an embodiment” mean that the feature being referred to is included in at least one embodiment of the present invention. Further, separate references to “one embodiment” or “an embodiment” in this description do not necessarily refer to the same embodiment; however, such embodiments are also not mutually exclusive unless so stated, and except as will be readily apparent to those skilled in the art from the description. For example, a feature, structure, act, etc. described in one embodiment may also be included in other embodiments. Thus, the present invention can include a variety of combinations and/or integrations of the embodiments described herein.

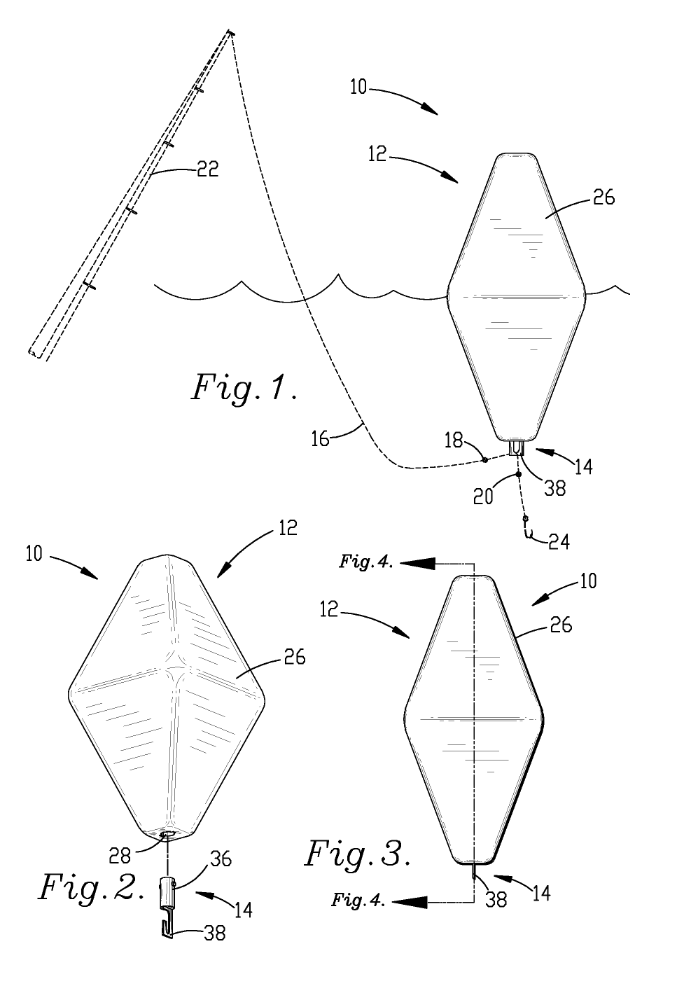

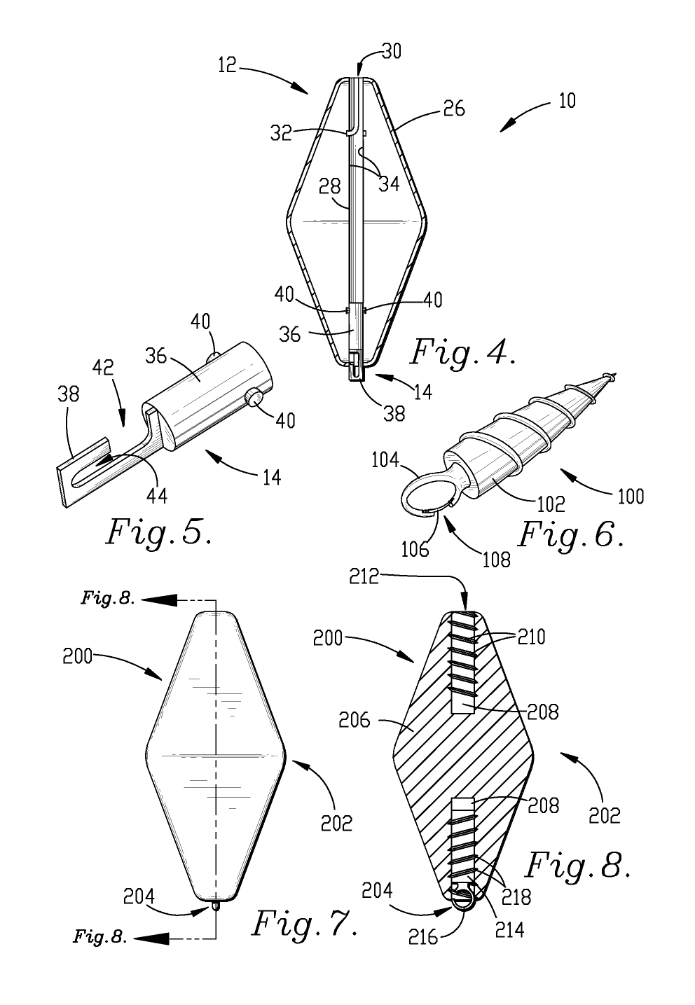

Turning now to the drawing figures and, in particular, FIGS. 1-5, a slip bobber 10 constructed in accordance with an embodiment of the invention is illustrated and broadly comprises a float 12 and a line retainer 14. In use, the line retainer 14 is secured to a line 16 between a proximal line stop 18, and a distal line stop 20. The line 16 is secured to a fishing pole 22 at the proximal end of the line 16 and to a catching mechanism 24, such as a hook, at the distal end of the line 16, as discussed in more detail below.

The float 12 supports the line retainer 14, provides visual indicia of fish activity, and further comprises a float body 26 and a line retainer receiver 28. The float body 26 floats in water and may be any shape such as spherical, hexahedral, octahedral, icosahedral, or the like. The float body 26 may be any size and may be fabricated from various materials, such as plastic, foam, wood, elastomeric material, or the like, or combinations thereof. In some embodiments the float body 26 may be hollow, and in others, the float body 26 may be solid. In the embodiment shown in FIGS. 1-5, the float body 26 is octahedral, hollow, and fabricated from acrylonitrile butadiene styrene (ABS). In various embodiments, an external surface of the float body 26 is colored to improve visibility of the float body 26. The color may be a surface coloring agent, such as paint, dye, or the like, or the float body 26 may be fabricated from a material of a particular color, such as colored plastic, foam, or the like. In some embodiments, the float body 26 is colored in two or more colors. In embodiments where the float body 26 is two colors, a first half of the float body 26 may be colored white, or a light color, and a second half may be colored black or a dark color. In other embodiments, the float body 26 may be colored in alternating stripes, dots, or various patterns to improve visibility in a variety of conditions. In various embodiments, the color of the float body 26 may include words, logos, designs, or the like.

The line retainer receiver 28 is a generally cylindrical body with a central void 30 disposed along a longitudinal axis of the line retainer receiver 28. The line retainer receiver 28 is disposed along a longitudinal axis of the float body 26 and removably secures the line retainer 14 therein. The line retainer receiver 28 may be fabricated from foam, plastic, metal, elastomeric material, or the like, and, in some embodiments, is secured within the float body 26 with fasteners, adhesives, or the like, to form a unitary whole. In other embodiments, the line retainer receiver 28 is incorporated as an integral portion of the float body 26 and, thus, no fasteners, adhesive, or the like, are necessary. In this embodiment, the line retainer receiver 28 includes a substantially continuous central void 30 but, in other embodiments, the line retainer receiver 28 may include a first central void 30 accessible from a first end of the line retainer receiver 28 and a second central void 30 accessible from a second end of the line retainer receiver 28. In yet other embodiments, a pair of line retainer receivers 28 may be used and placed at opposite ends of the longitudinal axis of the float body 26. In some embodiments, the line retainer receiver 28 further includes a channel 32 along an interior wall 34 for positioning and securing the line retainer 14 within the line retainer receiver 28 in a cam and cam-follower arrangement.

As most clearly shown in FIG. 5, the line retainer 14 slidably and removably attaches the line 16 to the float 18 and further includes a line retainer body 36, a clip 38, and, in some embodiments, a securing mechanism 40. The line retainer body 36 fits within the central void 30 of the line retainer receiver 28 to secure the line retainer 14 to the float 12. In this embodiment, the line retainer body 36 is generally cylindrical, though in various embodiments, the line retainer body 36 may be various shapes. The line retainer body 36 may be fabricated from plastic, metal, elastomeric material, or the like. In some embodiments, the line retainer receiver 28 extends through opposing sides of the float body 26 and, thus, the line retainer 14 may be inserted on either end of the line retainer receiver 28.

The clip 38 is disposed on an end of the line retainer body 36 for slidably and removably securing the line 16 therewithin. In this embodiment, the clip 38 is substantially J-shaped and includes gap 42 for allowing the line 16 within its concave inner portion 44. The clip 38 may be fabricated from metal, plastic, or the like, and is secured to the line retainer body 36 with adhesives, fasteners, or the like. In some embodiments, the clip 38 is integrally formed with the line retainer body 36 as a unitary whole and, thus, no adhesives are necessary. In some embodiments, the clip 38 is operable to, at least partially, fit within central void 30 of the line retainer receiver 28.

The securing mechanism 40 removably secures the line retainer 14 to the line retainer receiver 28. In one embodiment, the securing mechanism 40 is an ear that is operable to slide within the channel 32 and to be removably secured therein in a cam and cam-follower arrangement. In another embodiment, the securing mechanism 40 is a helical flange or ridge, like a screw, bolt, lug, or the like, operable to removably secure the line retainer 14 to the line retainer receiver 28. The securing mechanism 40 may be fabricated from metal, plastic, or the like, and is secured to the line retainer body 36 with adhesives, fasteners, or the like. In some embodiments, the securing mechanism 40 is integrally formed with the line retainer body 36 as a unitary whole and, thus, no adhesives are necessary.

The proximal line stop 18 limits the motion of the line retainer 14 along the line 16. The proximal line stop 18 may be a knot in the line 16 or, in some embodiments, may be a separately formed body removably secured to the line 16, such as a tied loop of fishing line, a disc, sphere, or the like. In these embodiments, the proximal line stop 18 may be crimped onto the line 16 or otherwise attached in some way and may be fabricated from fishing line, metal, plastic, elastomeric material, or the like.

The distal line stop 20 limits the motion of the line retainer 14 along the line 16. The distal line stop 20 may be a knot in the line 16 or, in some embodiments, may be a separately formed body removably secured to the line 16, such as a tied loop of fishing line, a disc, sphere, or the like. In these embodiments, the distal line stop 20 may be crimped onto the line 16 or otherwise attached in some way and may be fabricated from fishing line, metal, plastic, elastomeric material, or the like.

In use, the proximal line stop 18 is attached to the line 16 at a first location from the fishing pole 22. The distal line stop 20 is placed on the line 16 at a second location distal from the first location along the line 16 from the fishing pole 22. The line retainer 14 is slidably secured to the line 16 by engaging the line 16 within the concave inner portion 44 of the clip 26 between the proximal line stop 18 and the distal line stop 20. Thus, the line retainer 14 is operable to slide between a proximal position, wherein the line retainer 14 is disposed immediately distal of the proximal line stop 18, and a distal position, wherein the line retainer 14 is disposed immediately proximal of the distal line stop 20.

The line retainer 14 is placed within the central void 30 of the line retainer receiver 28 and the line retainer is secured within the central void 30 of the line retainer receiver 28, as shown in FIGS. 1, 3, and 4. Because the gap 42 is completely covered by the line retainer receiver 28 and within the central void 30 of the line retainer receiver 28, the line 16 cannot be removed from the line retainer 14 without removing the line retainer 14 from the line retainer receiver 28. A catching mechanism 24 is disposed on the distal end of the line 16. Removal the slip bobber 10 may be performed using substantially reversing the above procedure.

To cast the slip bobber 10 and the catching mechanism 24, the line 16 is retracted toward the fishing pole 22 to minimize the length of line 16 extending from the end of the fishing pole 22. The line 16 is cast in a substantially conventional manner and, when the slip bobber 10 and the catching mechanism 24 strike the body of water, a buoyant force of the float 12 causes the slip bobber 10 to stay at or near the surface of the water. The weight of the catching mechanism 24, conversely, causes it to fall deeper into the water and exerts a generally downward force on the line 16. Thus, the line 16 slides through the clip 38 of the line retainer 14. When the proximal line stop 18 touches the line retainer 14, the line 16 is prevented from sliding through the clip 38 further and the catching mechanism is suspended in the water by the buoyant force of the float 12. If the buoyant force of the float 12 is greater than the weight of the catching mechanism 24, the slip bobber 10 remain at or near the surface of the water and the catching mechanism 24 is suspended in the water at a depth approximately equal to the distance from the catching mechanism 24, along the line 16, to the proximal line stop 18. Additionally, the weight of the catching mechanism 24 orients the float 12 in the water so the clip 38 of the line retainer 14 is at the lowest point. When the buoyant force of the float 12 is slightly greater than the weight of the catching mechanism 24, the float 12 will rest in the water so that the water level is generally at a mid-line of the float 12. Thus, an upper half of the flat 12 is not submerged and a lower half of the float 12 is submerged and the line retainer 14 is at the bottom of the lower half of the float 12.

When a fish strikes the catching mechanism 24, the fish may push up on the catching mechanism 24, reducing the downward force exerted by the catching mechanism 24 on the slip bobber 10 and, thus, causing the float 12 to rise and, due to its shape, tip to a side. Alternatively, the fish may pull the catching mechanism 24 deeper in the water increasing the downward force on the slip bobber 10 and thereby submerging more of the float 12. Thus, the float 12 aids in the recognition of a fish strike. Additionally, the color of the float 12 aids in the recognition of fish strikes by improving visibility by allowing smaller changes in the position of the float 12 to be easily recognized. Thus, the slip bobber 10 is useful for small fish that cause smaller changes in the position of the float 12. Additionally, in embodiments where the float 18 has generally flat sides, such as in embodiments with a hexahedral, an octahedral, or an icosahedral-shaped float body 26, sunlight reflecting on the generally flat sides of the float 12 allows the position of the float 12 to be more easily recognized. When the float 12 is moved, the user is warned of the potential presence of a fish and thereby the user can use their experience to determine when to jerk the fishing pole 22 to “set the hook.”

In some situations it may be prudent to change the color of the float 12 to adjust for changing environmental conditions, to change the fishing style, or the like. In these situations, the float 12 may be easily removed from the line retainer 14 and another float of an alternate color, shape, or size, or a combination thereof, may be easily substituted. Additionally, the slip bobber 10 is easily removed to, for example, switch to straight-line fishing.

Turning now to FIG. 6, another embodiment of a line retainer 100 that may be used with an embodiment of a slip bobber is shown. In this embodiment, the line retainer 100 further comprises a line retainer body 102, an eye 104, and a spring 106. In this embodiment, the line retainer body 102 is threaded, like a screw, to be fixably secured within a line retainer receiver or directly within a float body. The eye portion 104 slidably secures a line and is a generally toroidal and includes a gap 108. The spring 106 is secured on one end to the eye 104 and enables the line to be placed within the eye 104 and prevents the line from being inadvertently removed from the within the eye 104. In some embodiments, the line retainer 100 may be operable to be inserted within the line retainer receiver so the gap 108 is within the line retainer receiver. Thus, the line is prevented from escaping from the line retainer 100.

Turning now to FIGS. 7-8, another embodiment of a slip bobber 200 is illustrated. The slip bobber 200 of this embodiment is substantially similar to the slip bobber 10 of FIGS. 1-5, except as indicated. In this embodiment the slip bobber 200 broadly comprises a float 202, a line retainer 204.

The float 202 is substantially similar to the float body 12 of FIGS. 1-5, except as indicated. The float 202 further includes a float body 206 and a line retainer receiver 208. The float body 206 is fabricated from closed-cell extruded polystyrene foam and further comprises a pair of line retainer receivers 208 disposed on opposing ends of the float body 206. Each line retainer receiver 208 is fabricated from ABS and further includes a helical channel 210 around the inner radial edge of a central void 212.

The line retainer 204 is substantially similar to the line retainer 14 of FIGS. 1-5, except as indicated. In this embodiment, the line retainer 204 further includes a line retainer body 214, a clip 216, and a securing mechanism 218. In this embodiment, the securing mechanism 218 is a helical flange extending radially around a peripheral face of the line retainer body 214. Thus, the securing mechanism 218 is operable to matingly engage the helical channel 210 to secure the line retainer 204 within one of the line retainer receivers 208.

Although the invention has been described with reference to the preferred embodiment illustrated in the attached drawing figures, it is noted that equivalents may be employed and substitutions made herein without departing from the scope of the invention as recited in the claims.

What is claimed is:

1. A slip bobber comprising:
a float including—
a float body, and
a line retainer receiver disposed within the float body, a portion of the line retainer receiver at least partially extending through an exterior face of the float body, and
a line retainer including—
a line retainer body,
a clip operable to secure a fishing line therewithin and disposed on the line retainer body, and
a securing mechanism disposed on the line retainer body for removably securing the line retainer within the line retainer receiver.

2. The slip bobber of claim 1, wherein the float body comprises a plurality of substantially flat sides.

3. The slip bobber of claim 1, wherein the float body shape is chosen from the group consisting of ellipsoid, octahedral, pentagonal bipyramid, and triangular dipyramid.

4. The slip bobber of claim 1, wherein the securing mechanism is a pair of ears extending from opposing sides of the line retainer body and wherein the line retainer receiver further comprises a channel operable to matingly engage the securing mechanism therewithin.

5. The slip bobber of claim 1, wherein the securing mechanism is a helical flange extending from the peripheral side of the line retainer body and wherein the line retainer receiver further comprises a helical channel operable to matingly engage the securing mechanism therewithin.

6. The slip bobber of claim 1, wherein the float body is fabricated from a material chosen from the group consisting of plastic, foam, wood, and elastomeric material.

7. The slip bobber of claim 1, wherein the clip is substantially J-shaped and includes a gap for placing a line within a concave portion of the clip.

8. The slip bobber of claim 7, wherein the line retainer is operable to be received within the line retainer receiver so that the gap is covered by the line retainer receiver.

9. The slip bobber of claim 1, wherein the line retainer receiver is disposed on a longitudinal axis of the float body.

10. The slip bobber of claim 1, wherein the line retainer receiver is a first line retainer receiver and the float further includes a second line retainer receiver disposed on an exterior face of the float body on a substantially opposite side of the float body from the first line retainer receiver.

11. A slip bobber comprising:
a float including—
an octahedral float body, and
a line retainer receiver disposed within the float body, a portion of the line retainer receiver at least partially extending through an exterior face of the float body, and
a line retainer including—
a line retainer body,
a clip operable to secure a fishing line therewithin and disposed on the line retainer body, and
a securing mechanism disposed on the line retainer body for removably securing the line retainer within the line retainer receiver, the securing mechanism operable to be matingly received within the line retainer receiver.

12. The slip bobber of claim 11, wherein the line retainer receiver is disposed on a longitudinal axis of the float body.

13. The slip bobber of claim 11, wherein the line retainer receiver is a first line retainer receiver and the float further includes a second line retainer receiver disposed on an exterior face of the float body on a substantially opposite side of the float body from the first line retainer receiver.

14. The slip bobber of claim 11, wherein the float body fabricated from a material chosen from the group consisting of plastic, foam, wood, and elastomeric material.

15. The slip bobber of claim 11, wherein the clip includes a gap for placing a line within a concave inner portion of the clip.

16. The slip bobber of claim 15, wherein the clip spring further comprises a spring for closing the gap.

17. A slip bobber comprising:
a float including—
a float body including a plurality of substantially flat sides, the float body having a longitudinal axis, and
a line retainer receiver disposed within the float body and along its the longitudinal axis, a first portion of the line retainer receiver at least partially extending through a first location on the float body and a second portion of the line receiver at least partially extending though a second location on the float body, the first location and the second location on substantially opposing sides of the float body, and
a line retainer including—
a line retainer body,
a clip including a gap for placing a line within a concave inner portion of the clip and disposed on a first end of the line retainer body, and
a securing mechanism disposed on a second end of the line retainer body for removably securing the line retainer within the line retainer receiver,
wherein the line retainer is operable to be received within the line retainer receiver so that the gap is covered by the line retainer receiver.

18. The slip bobber of claim 17, wherein the float body shape is chosen from the group consisting of an octahedral, a pentagonal bipyramid, and a triangular dipyramid.

19. The slip bobber of claim 17, wherein the securing mechanism is a pair of ears extending from opposing sides of the line retainer body and wherein the line retainer receiver includes a channel operable to matingly engage the securing mechanism therewithin.

20. The slip bobber of claim 17, wherein the securing mechanism is a helical flange extending from the peripheral side of the line retainer body and wherein the line retainer receiver includes a helical channel operable to matingly engage the securing mechanism therewithin.
